(19) United States
(12) Patent Application Publication
(10) Pub. No.: US 2010/0172068 A1
(43) Pub. Date: Jul. 8, 2010

(54) SOLID ELECTROLYTIC CAPACITOR AND METHOD OF MANUFACTURING THE SAME

(75) Inventor: Satoru Yoshimitsu, Kishima-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO Electric Co., Ltd., Osaka (JP); SAGA SANYO INDUSTRIES Co,. Ltd., Kishima-gun (JP)

(21) Appl. No.: 12/650,788

(22) Filed: Dec. 31, 2009

(30) Foreign Application Priority Data
Jan. 8, 2009 (JP) 2009-002861

(51) Int. Cl. H01G 9/025; B05D 5/12

(52) U.S. Cl. 361/525; 427/80

(57) ABSTRACT

Provided are a solid electrolytic capacitor including an anode having a dielectric coating film on a surface thereof and a solid electrolyte layer including a conductive polymer, the solid electrolyte layer containing a cyclic siloxane and a chelating agent, and a method of manufacturing the same.

### BACKGROUND OF THE INVENTION

1. Field of the Invention

The present invention relates to a solid electrolytic capacitor and a method of manufacturing the solid electrolytic capacitor.

2. Description of the Background Art

Recently, there is a demand for a solid electrolytic capacitor having a smaller size, a larger capacity, a lower impedance in a high frequency region, and a high heat resistance. This demand is caused as electronic equipment is more digitalized and uses a higher frequency and reflow temperature is increased by using lead-free soldering.

A solid electrolytic capacitor having a smaller size, a larger capacity, and a lower impedance in a high frequency region can be realized by a winding-type solid electrolytic capacitor in which a capacitor element formed by winding a cathode foil and an anode foil with a separator being interposed therebetween is accommodated in a metal case and sealed with sealing rubber.

In a solid electrolytic capacitor, a conductive polymer having a high conductivity such as polypyrrole or polythiophene is used as a solid electrolyte layer. Among such conductive polymers, polyethylenedioxythiophene (PEDT) having a relatively slow polymerization reaction speed and an excellent adhesion property with a dielectric coating film on a surface of an anode foil is attracting attention at present. A solid electrolytic capacitor fabricated by impregnating a capacitor element formed by winding an anode foil and a cathode foil with a separator being interposed therebetween with a monomer and para toluene sulfonic acid ferric salt as an oxidant, and producing polyethylenedioxythiophene inside the capacitor element by a chemical polymerization reaction between the monomer and the oxidant that occurs mildly thereafter has been realized.

### SUMMARY OF THE INVENTION

In the winding-type solid electrolytic capacitor, however, it is difficult to impregnate a winding-type capacitor element with a conductive polymer evenly and sufficiently. In particular, polyethylenedioxythiophene made by polymerizing dioxythiophene has a problem of having variations in electric properties due to differences among various oxidants used, specifically, a difference between lots of an oxidant solution, differences in conditions of the polymerization reaction such as a polymerization temperature and a reaction temperature, a difference in elapsed time from when an oxidant solution is formulated to when a monomer of the conductive polymer is polymerized, or the like. Examples of the variations in electric properties caused include variations in capacitance determined by a coverage rate of the conductive polymer onto a dielectric coating film, and variations in equivalent series resistance (ESR) in a high frequency region determined by a filling rate of the conductive polymer.

Further, a sulfonic acid metal salt serving as an oxidant and dopant, for example, para toluene sulfonic acid ferric salt remains in a large amount in a solid electrolyte layer of the solid electrolytic capacitor after a chemical polymerization reaction of a precursor monomer of the conductive polymer, for example, 3,4-ethylenedioxythiophene. Most of the remaining sulfonic acid metal salt remains as sulfonic acid ferrous salt and sulfonic acid ferric salt. Since these sulfonic acid metal salts have high deliquescence, when the solid electrolytic capacitor is used under a high humidity environment for a long time, these salts are diffused throughout a rubber sealing portion and absorb moisture penetrating into the solid electrolytic capacitor. The absorbed moisture produces a large amount of sulfonic acid anions inside the solid electrolytic capacitor, and deteriorates the dielectric coating film on the anode foil. Therefore, it causes a reduction in the capacitance and an increase in the ESR in durability and heat resistance tests.

Furthermore, at the time of a reflow process for mounting the solid electrolytic capacitor on a printed board, and in the durability and heat resistance tests in which the solid electrolytic capacitor is placed under a high temperature environment for a long time, the sulfonic acid metal salt remaining in a large amount for the reason as described above is considered to serve as a reducing agent reducing the dielectric coating film on the anode foil and the like. In that case, defective portions lacking oxygen are generated in the reduced dielectric coating film, resulting in an increase in leak current (LC) or a short circuit failure in the solid electrolytic capacitor. Deterioration in the electric properties of the solid electrolytic capacitor or an increase in the short circuit failure in the solid electrolytic capacitor, due to deterioration of the conductive polymer caused by various factors as described above, has become a problem that cannot be overlooked in the market.

From the viewpoint described above, for example, a technique of removing metal ions contained in an oxidant from a capacitor element by containing a chelating compound in a cleaning liquid used to clean the capacitor element after polymerizing a conductive polymer has been disclosed (see Japanese Patent Laying-Open No. 2006-104314).

Further, development of a solid electrolytic capacitor in which a conductive polymer is difficult to be deteriorated, and which has high electric properties and less short circuit failures has been desired.

The present invention has been made to solve the problems as described above. That is, one object of the present invention is to provide a solid electrolytic capacitor including an anode having a dielectric coating film on a surface thereof and a solid electrolyte layer including a conductive polymer, with impurities in the solid electrolyte layer such as iron salt, excessive organic sulfonic acid, and unreacted precursor monomer being removed, and a method of manufacturing the same.

Further, another object of the present invention is to provide a highly reliable solid electrolytic capacitor in which chemical change of a conductive polymer is suppressed, and a method of manufacturing the same.

A first aspect of the present invention relates to a solid electrolytic capacitor including an anode having a dielectric coating film on a surface thereof and a solid electrolyte layer including a conductive polymer, the solid electrolyte layer containing a cyclic siloxane and a chelating agent.

Preferably, in the solid electrolytic capacitor of the present invention, the cyclic siloxane includes at least one selected from hexamethyl cyclotrisiloxane, octamethyl cyclotetrasiloxane, decamethyl cyclopentasiloxane, and dodecamethyl cyclohexasiloxane.

Preferably, in the solid electrolytic capacitor of the present invention, the chelating agent includes at least one selected from ethylenediamine tetraacetic acid (EDTA), propanediamine tetraacetic acid (PDTA), diaminohydroxypropane tetraacetic acid (DPTA), nitrilo triacetic acid (NTA), glycol ether diamine tetraacetic acid (GEDTA), diethylenetriamine pentaacetic acid (DTPA), hydroxyethylethylenediamine triacetic acid (HEDTA), and triethylenetetramine hexaacetic acid (TTNA).

A second aspect of the present invention relates to a method of manufacturing a solid electrolytic capacitor including an anode having a dielectric coating film on a surface thereof and a solid electrolyte layer including a conductive polymer, the method including the steps of: preparing a polymerization liquid by mixing a precursor monomer of the conductive polymer and a dopant and oxidant solution containing a sulfonic acid metal salt, a cyclic siloxane, and a chelating agent; bringing the polymerization liquid into contact with the dielectric coating film; and forming the conductive polymer by polymerizing the precursor monomer in contact with the dielectric coating film.

A third aspect of the present invention relates to a method of manufacturing a solid electrolytic capacitor including an anode having a dielectric coating film on a surface thereof and a solid electrolyte layer including a conductive polymer, the method including the steps of: preparing a dopant and oxidant solution containing a sulfonic acid metal salt, a cyclic siloxane, and a chelating agent; preparing a polymerization liquid by mixing the dopant and oxidant solution and a precursor monomer of the conductive polymer; bringing the polymerization liquid into contact with the dielectric coating film; and forming the conductive polymer by polymerizing the precursor monomer in contact with the dielectric coating film.

A fourth aspect of the present invention relates to a method of manufacturing a solid electrolytic capacitor including an anode having a dielectric coating film on a surface thereof and a solid electrolyte layer including a conductive polymer, the method including the steps of: preparing a dopant and oxidant solution containing a sulfonic acid metal salt, a cyclic siloxane, and a chelating agent, and bringing the dopant and oxidant solution into contact with the dielectric coating film; bringing a precursor monomer of the conductive polymer into contact with the dielectric coating film; and forming the conductive polymer by polymerizing the precursor monomer in contact with the dielectric coating film.

A fifth aspect of the present invention relates to a method of manufacturing a solid electrolytic capacitor including an anode having a dielectric coating film on a surface thereof and a solid electrolyte layer including a conductive polymer, the method including the steps of: bringing a precursor monomer of the conductive polymer into contact with the dielectric coating film; preparing a dopant and oxidant solution containing a sulfonic acid metal salt, a cyclic siloxane, and a chelating agent, and bringing the dopant and oxidant solution into contact with the dielectric coating film; and forming the conductive polymer by polymerizing the precursor monomer in contact with the dielectric coating film.

Preferably, in the method of manufacturing a solid electrolytic capacitor of the second to fifth aspects described above, the cyclic siloxane in the dopant and oxidant solution has a concentration of 5 to 20 wt %.

Preferably, in the method of manufacturing a solid electrolytic capacitor of the second to fifth aspects described above, the chelating agent in the dopant and oxidant solution has a concentration of 0.1 to 1.0 wt %.

Preferably, the method of manufacturing a solid electrolytic capacitor of the second to fifth aspects described above further includes the step of cleaning the anode with a cleaning liquid containing an aromatic sulfonic acid after bringing the polymerization liquid including the dopant and oxidant solution and the precursor monomer into contact with the dielectric coating film.

Preferably, in the method of manufacturing a solid electrolytic capacitor of the second to fifth aspects described above, the aromatic sulfonic acid contained in the cleaning liquid has a concentration of 0.5 to 3.0 wt %.

The present invention can provide a solid electrolytic capacitor including an anode having a dielectric coating film on a surface thereof and a solid electrolyte layer including a conductive polymer, with impurities in the solid electrolyte layer such as iron salt, excessive organic sulfonic acid, and unreacted precursor monomer being removed, and a method of manufacturing the same.

Further, the present invention can provide a highly reliable solid electrolytic capacitor in which chemical change of a conductive polymer is suppressed, and a method of manufacturing the same. It is to be noted that, in the present specification, the precursor monomer does not have to be a monomer, and also includes a low molecular oligomer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing a winding-type capacitor element in a solid electrolytic capacitor of one embodiment of the present invention.

FIG. 2 is a cross sectional view of the solid electrolytic capacitor of one embodiment of the present invention.

### DESCRIPTION OF THE PREFERRED EMBODIMENTS

Hereinafter, an embodiment of the present invention will be described with reference to the drawings. It is to be noted that identical or corresponding parts below in the drawings will be designated by the same reference numerals, and the description thereof will not be repeated. Further, dimensional relations among lengths, sizes, widths, and the like in the drawings are changed as appropriate for clarity and simplicity of the drawings, and do not represent actual dimensions.

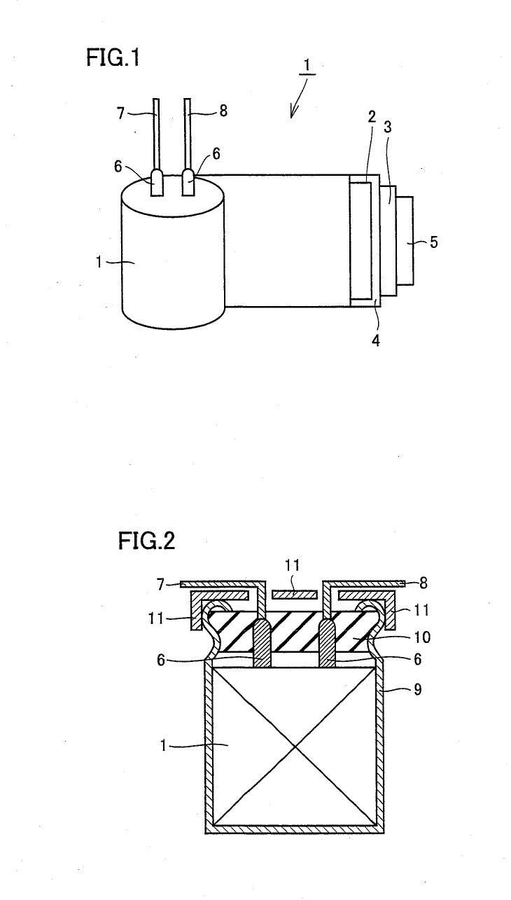

Firstly, a winding-type capacitor element will be described with reference to FIG. 1. It is to be noted that a solid electrolytic capacitor of the present invention is not limited to a winding-type solid electrolytic capacitor, and the present invention is applicable to a solid electrolytic capacitor of a known shape. Concrete examples of the solid electrolytic capacitor of a known shape include a solid electrolytic capacitor using a sintered body of a valve metal, and a multi-layered type solid electrolytic capacitor using plates of a valve metal.

A winding-type capacitor element 1 in the present embodiment has a basic structure formed by cylindrically winding an anode foil 2 as an anode and a cathode foil 3 with a separator sheet 4 being interposed therebetween. Winding-type capacitor element 1 includes a solid electrolyte layer (not shown) including a conductive polymer at a gap between anode foil 2 and cathode foil 3. As anode foil 2, a valve metal such as aluminum, tantalum, and niobium subjected to etching treatment, chemical conversion treatment, and the like can be used. As cathode foil 3 and separator sheet 4, known materials can be selected and used as appropriate, respectively. Dimensions such as a thickness of anode foil 2, cathode foil 3, and separator sheet 4 can be selected as appropriate.

Lead tab terminals 6 are electrically connected to anode foil 2 and cathode foil 3, respectively. Lead tab terminal 6 connected to anode foil 2 is electrically connected to an anode lead 7, and lead tab terminal 6 connected to cathode foil 3 is electrically connected to a cathode lead 8. An anode terminal is formed by lead tab terminal 6 and anode lead 7, and a cathode terminal is formed by lead tab terminal 6 and cathode lead 8.

In the present invention, the solid electrolyte layer includes the conductive polymer. Further, the solid electrolyte layer contains a cyclic siloxane and a chelating agent. When a precursor monomer of the conductive polymer is polymerized in a series of steps of manufacturing the solid electrolytic capacitor, a sulfonic acid metal salt is used as a dopant and oxidant. In a case where the solid electrolyte layer contains, for example, only a chelating agent and does not contain a cyclic siloxane, the chelating agent removes unnecessary metal ions. On the other hand, however, sites where the metal ions existed in the solid electrolyte layer become voids, and the presence of the voids makes the solid electrolyte layer mechanically weak. As a result, an adverse effect such as occurrence of a short circuit failure in the solid electrolytic capacitor may be caused. However, in a case where the solid electrolyte layer contains a cyclic siloxane and a chelating agent, the voids are filled with the cyclic siloxane, which makes the solid electrolyte layer mechanically strong. Therefore, the solid electrolytic capacitor in accordance with the present invention has less short circuit failures and is excellent in heat resistance.

The precursor monomer of the conductive polymer of the present invention is preferably any of thiophene, pyrrole, aniline, and derivatives thereof, and particularly preferably 3,4-ethylenedioxythiophene. Since the conductive polymer made by polymerizing the precursor monomer described above has a higher electric conductivity when compared with other conductive polymers, the solid electrolytic capacitor can have a reduced ESR and an increased heat resistance.

The sulfonic acid metal salt serves as an oxidant and a dopant, as described above. Examples of a portion constituting a sulfonic acid of the sulfonic acid metal salt include an alkyl sulfonic acid, an aromatic sulfonic acid, and a polycyclic aromatic sulfonic acid. A portion constituting a metal salt of the sulfonic acid metal salt can be selected as appropriate from iron (III), copper (II), chromium (IV), cerium (IV), ruthenium (III), zinc (II), and the like.

Further, the cyclic siloxane preferably includes at least one selected from hexamethyl cyclotrisiloxane, octamethyl cyclotetrasiloxane, decamethyl cyclopentasiloxane, and dodecamethyl cyclohexasiloxane, because these are low toxic substances among siloxane compounds, and their material costs are inexpensive.

Furthermore, the chelating agent preferably includes at least one selected from ethylenediamine tetraacetic acid, propanediamine tetraacetic acid, diaminohydroxypropane tetraacetic acid, nitrilo triacetic acid, glycol ether diamine tetraacetic acid, diethylenetriamine pentaacetic acid, hydroxyethylethylenediamine triacetic acid, and triethylenetetramine hexaacetic acid, and is particularly preferably ethylenediamine tetraacetic acid, because these have a high chelating effect on metal ions contained in the sulfonic acid metal salt.

As shown in FIG. 2, to form the solid electrolytic capacitor of the present embodiment, winding-type capacitor element 1 is accommodated in a bottomed case 9 made of aluminum or the like, and sealed in bottomed case 9 with a sealing member 10 and a seat plate 11 except for parts of electrode terminals including anode lead 7 and cathode lead 8 in winding-type capacitor element 1. Although the solid electrolytic capacitor of the present embodiment shown in FIG. 2 is provided with seat plate 11, there is no problem even when seat plate 11 is not provided.

As sealing member 10, for example, epoxy resin, butyl rubber having low permeability and high heat resistance, or the like can be used.

### <Method of Manufacturing Solid Electrolytic Capacitor>

A method of manufacturing the solid electrolytic capacitor in accordance with the present embodiment will be described with reference to FIGS. 1 and 2.

Firstly, a metal foil is subjected to etching treatment, chemical conversion treatment, and the like using known methods to prepare anode foil 2 as an anode having a dielectric coating film on a surface thereof. Then, anode lead 7 is attached to anode foil 2 through lead tab terminal 6. Next, cathode lead 8 is attached to cathode foil 3 through lead tab terminal 6. Subsequently, anode foil 2 and cathode foil 3 are wound with separator sheet 4 being interposed therebetween, and secured with a winding stop tape 5. Thereby, the basic structure of a winding-type capacitor element (hereinafter referred to as a wound portion) is formed. Thereafter, the wound portion is subjected to chemical conversion treatment of a cut section using a known method, and subjected to heat treatment at 150 to 300° C.

### <<Preparation of Dopant and Oxidant Solution Containing Sulfonic Acid Metal Salt, Cyclic Siloxane, and Chelating Agent>>

In the present step, a dopant and oxidant solution containing a chelating agent, a cyclic siloxane, and a sulfonic acid metal salt is prepared. The sulfonic acid metal salt serves as an oxidant and dopant. Generally, a series of steps of manufacturing a solid electrolytic capacitor includes a step of cleaning a wound portion with water. In such a step, there has been a problem that voids are generated at an interface between a dielectric coating film and a solid electrolyte layer, which deteriorates adhesive property between the dielectric coating film and the solid electrolyte layer at the interface and causes an increase in the ESR of the solid electrolytic capacitor.

However, since the dopant and oxidant solution contains a cyclic siloxane, even in a case where voids as described above are generated in a later step, the voids are filled with the cyclic siloxane. Thereby, the adhesive property between the dielectric coating film and the solid electrolyte layer can be maintained, and an increase in the ESR can be suppressed.

On this occasion, it is particularly preferable that the cyclic siloxane in the dopant and oxidant solution has a concentration of 5 to 20 wt %. If the cyclic siloxane has a concentration of less than 5 wt %, the cyclic siloxane has poor ability to fill voids as sites where metal ions removed from the solid electrolyte layer existed, for example, sites where Fe³⁺ ions existed. If the cyclic siloxane has a concentration of more than 20 wt %, excessive cyclic siloxane remains in the solid electrolyte layer and may cause an increase in the ESR of the solid electrolytic capacitor.

Further, it is particularly preferable that the chelating agent in the dopant and oxidant solution has a concentration of 0.1 to 1.0 wt %. If the chelating agent has a concentration of less than 0.1 wt %, the chelating effect of forming a complex of metal ions such as Fe³⁺ and removing them from the solid electrolyte layer may be weakened. If the chelating agent has a concentration of more than 1.0 wt %, metal ions such as Fe³⁺ remain excessively in the solid electrolyte layer and may cause an increase in the ESR of the solid electrolytic capacitor. It is to be noted that the chelating agent, the cyclic siloxane, and the sulfonic acid metal salt can be selected from the materials described above and used as appropriate, respectively.

### <<Mixing of Dopant and Oxidant Solution and Precursor Monomer of Conductive Polymer>>

The dopant and oxidant solution and a precursor monomer of the conductive polymer are mixed such that a weight ratio between the dopant and oxidant solution and the precursor monomer of the conductive polymer is 1:1 to 5:1, to manufacture a polymerization liquid. Polymerization of the precursor monomer gradually proceeds from when the polymerization liquid is prepared. Although a method of preparing a dopant and oxidant solution and then mixing a precursor monomer to the dopant and oxidant solution has been described herein, a polymerization liquid may also be prepared by simultaneously mixing the materials to be contained in a dopant and oxidant solution and a precursor monomer. In this case, the polymerization liquid can be prepared in a simpler step. However, since unnecessary heat generation can be suppressed by preparing a dopant and oxidant solution separately, the steps described below can be carried out more safely when a dopant and oxidant solution is prepared and then a precursor monomer is mixed to the dopant and oxidant solution. The precursor monomer in the present step is preferably any of thiophene, pyrrole, aniline, and derivatives thereof.

<<Contact of Polymerization Liquid with Dielectric Coating Film>>

In the present step, the polymerization liquid is brought into contact with the dielectric coating film. Specifically, the wound portion formed in the above step is immersed in the polymerization liquid. Thereby, a gap between anode foil 2 having the dielectric coating film and cathode foil 3 is filled with the polymerization liquid.

<<Cleaning with Cleaning Liquid Containing Aromatic Sulfonic Acid>>

The wound portion filled with the polymerization liquid is immersed in a cleaning liquid to clean the anode in contact with the polymerization liquid. On this occasion, the polymerization liquid is in a semisolid state. Immersion time is preferably several seconds to one minute. The cleaning liquid is preferably an aqueous solution containing an aromatic sulfonic acid, because, if the cleaning liquid is water only, dedoping of the conductive polymer by water as a cleaning medium thereof is likely to occur. Herein, dedoping refers to a phenomenon such as disappearance of polaron and bipolaron in a conductive polymer chain.

To replenish the solid electrolyte layer with a dopant necessary to restore conductivity reduced by dedoping due to cleaning, it is particularly preferable that the aromatic sulfonic acid contained in the cleaning liquid has a concentration of 0.5 to 3.0 wt %. If the aromatic sulfonic acid has a concentration of less than 0.5 wt %, the effect of replenishment with the dopant described above may not be sufficiently exhibited. If the aromatic sulfonic acid has a concentration of more than 3.0 wt %, an excessive acid component remains on the solid electrolyte layer, and may result in occurrence of a short circuit failure in a heat resistance test of the solid electrolytic capacitor.

Further, the precursor monomer may be polymerized by heat and thereafter the wound portion may be immersed in the cleaning liquid to clean the anode, as described later. Also in this case, the cleaning liquid preferably contains an aromatic sulfonic acid. However, it is preferable to clean the anode within one minute from when the wound portion is immersed in the polymerization liquid. This is because, since the polymerization liquid is gradually polymerized from when it is prepared, and is solidified over time, the longer time passes after immersion, the more difficult it becomes to physically remove metal ions by cleaning.

As the aromatic sulfonic acid, para toluene sulfonic acid can be used, and for example, methoxybenzenesulfonic acid, naphthalenesulfonic acid, phenolsulfonic acid, or dodecylbenzenesulfonic acid can also be used.

### <<Polymerization of Precursor Monomer to Form Conductive Polymer>>

As described above, polymerization of the polymerization liquid gradually proceeds from when it is prepared. In addition to this, the wound portion is further subjected to heat treatment at 180 to 270° C. to promote polymerization of the precursor monomer in the polymerization liquid. Thereby, the solid electrolyte layer is formed at the gap between anode foil 2 and cathode foil 3. With the steps described above, winding-type capacitor element 1 is completed.

### <<Finishing>>

Winding-type capacitor element 1 is accommodated in bottomed case 9 made of aluminum, and sealing member 10 for sealing a wound structure portion of capacitor element 1 inside bottomed case 9 is placed at an opening of bottomed case 9. Thereafter, sealing is performed by subjecting the opening of bottomed case 9 to pressing in a lateral direction and curling, and aging treatment is performed. Finally, seat plate 11 is provided on a curled surface at the opening of bottomed case 9, and anode lead 7 and cathode lead 8 as the electrode terminals are pressed and bent to complete the solid electrolytic capacitor.

### <<Manufacturing Method in Other Forms>>

Further, in a manufacturing method in another form of the present invention, to polymerize a precursor monomer and form a conductive polymer, for example, a dopant and oxidant solution containing a sulfonic acid metal salt, a cyclic siloxane, and a chelating agent may be prepared beforehand and brought into contact with a dielectric coating film, and thereafter the precursor monomer of the conductive polymer may be brought into contact with the dielectric coating film separately. In this case, the dopant and oxidant solution can be prepared to have a composition identical to that described above. After the precursor monomer is brought into contact with the dielectric coating film, an anode can be cleaned with a cleaning liquid containing an aromatic sulfonic acid.

Further, in a manufacturing method in still another form of the present invention, a precursor monomer of a conductive polymer may be brought into contact with a dielectric coating film, and thereafter a dopant and oxidant solution may be brought into contact with the dielectric coating film separately. Also in this case, the dopant and oxidant solution can be prepared to have a composition identical to that described above. After the dopant and oxidant solution is brought into contact with the dielectric coating film, a wound portion can be cleaned with a cleaning liquid containing an aromatic sulfonic acid.

### EXAMPLES

Hereinafter, the present invention will be described in more detail by taking examples. It is to be noted that the present invention is not limited to these examples.

### Example 1

A description will be given with reference to FIGS. 1 and 2.

Firstly, a metal foil was subjected to etching treatment, chemical conversion treatment, and the like using known methods to prepare anode foil 2 as an anode having a dielectric coating film on a surface thereof. Then, anode lead 7 was attached to anode foil 2 through lead tab terminal 6. Next, cathode lead 8 was attached to cathode foil 3 through lead tab terminal 6. Subsequently, anode foil 2 and cathode foil 3 were wound with separator sheet 4 made of synthetic cellulose fiber being interposed therebetWeen, and secured with winding stop tape 5. Thereby, a wound portion as a basic structure of a winding-type capacitor element was formed. Thereafter, the wound portion was subjected to chemical conversion treatment of a cut section and heat treatment at 280° C.

### <<Preparation of Dopant and Oxidant Solution Containing Sulfonic Acid Metal Salt, Cyclic Siloxane, and Chelating Agent>>

A dopant and oxidant solution containing a chelating agent, a cyclic siloxane, and a sulfonic acid metal salt was prepared. As the chelating agent, ethylenediamine tetraacetic acid (EDTA) was used, and as the cyclic siloxane, hexamethylcyclotrisiloxane was used. In the present example, a solution was prepared by mixing 4 grams of para toluene sulfonic acid ferric salt to 4.95 grams of n-butanol used as a solvent, and a dopant and oxidant solution was prepared by mixing the chelating agent and the cyclic siloxane to the solution such that concentrations of the chelating agent and the cyclic siloxane in the solution was 0.05 wt % and 10 wt %, respectively.

### <<Mixing of Dopant and Oxidant Solution and Precursor Monomer of Conductive Polymer>>

As a precursor monomer of a conductive polymer, 3,4-ethylenedioxythiophene was used. The dopant and oxidant solution and the precursor monomer of the conductive polymer were mixed such that a weight ratio between the dopant and oxidant solution and the precursor monomer of the conductive polymer was 2:1, to manufacture a polymerization liquid. Polymerization of the precursor monomer gradually proceeded from when the polymerization liquid was prepared.

<<Contact of Polymerization Liquid with Dielectric Coating Film>>

The formed wound portion was immersed in the polymerization liquid. Thereby, a gap between anode foil 2 having the dielectric coating film and cathode foil 3 was filled with the polymerization liquid.

<<Cleaning with Cleaning Liquid Containing Aromatic Sulfonic Acid>>

As a cleaning liquid, a 2 wt % aqueous solution of para toluene sulfonic acid as an aromatic sulfonic acid was prepared. Immediately after being immersed in the polymerization liquid, the wound portion was immersed in the cleaning liquid for ten seconds.

### <<Polymerization of Precursor Monomer to Form Conductive Polymer>>

As described above, polymerization of the polymerization liquid gradually proceeded from when it was prepared. The wound portion was further subjected to heat treatment at 250° C. to promote polymerization of 3,4-ethylenedioxythiophene as the precursor monomer in the polymerization liquid. With the present step, polyethylenedioxythiophene as the conductive polymer was formed. Thereby, a solid electrolyte layer was formed at the gap between anode foil 2 and cathode foil 3, and winding-type capacitor element 1 was manufactured.

### <<Finishing>>

Winding-type capacitor element 1 was accommodated in bottomed case 9 made of aluminum. Then, sealing member 10 for sealing a wound structure portion of capacitor element 1 inside bottomed case 9 was placed at an opening of bottomed case 9. Thereafter, sealing was performed by subjecting the opening of bottomed case 9 to pressing in a lateral direction and curling, and aging treatment was performed.

Finally, seat plate 11 made of plastic was provided on a curled surface at the opening of bottomed case 9, and anode lead 7 and cathode lead 8 as the electrode terminals were pressed and bent to complete a solid electrolytic capacitor.

### Examples 2 to 9

As the materials such as the chelating agent and the cyclic siloxane used to prepare respective dopant and oxidant solutions, the same materials as those used in Example 1 were selected, and respective solid electrolytic capacitors were manufactured by the same method as in Example 1 except for preparing the respective dopant and oxidant solutions in mixing ratios indicated in Table 1.

### Comparative Example 1

A solid electrolytic capacitor was manufactured by the same method as in Example 1 except for preparing a dopant and oxidant solution not containing both a chelating agent and a cyclic siloxane.

### Comparative Examples 2 and 3

As the materials such as the chelating agent and the cyclic siloxane used to prepare respective dopant and oxidant solutions, the same materials as those used in Example 1 were selected, and respective solid electrolytic capacitors were manufactured by the same method as in Example 1 except for preparing the respective dopant and oxidant solutions not containing the chelating agent or the cyclic siloxane as indicated in Table 1. Specifically, a dopant and oxidant solution not containing the cyclic siloxane was used in Comparative Example 2, and a dopant and oxidant solution not containing the chelating agent was used in Comparative Example 3.

TABLE 1

| | Concentration in Dopant and | | Dopant and Oxidant | | | After Reflow Test | | |
|---|---|---|---|---|---|---|---|---|
| | Oxidant Solution | | Solution (wt): | Initial | Initial | | | Number of Occurrence |
| | Chelating | Cyclic | Precursor Monomer | Capacitance | ESR | ΔC/C | | of Short Circuit |
| | Agent (wt %) | Siloxane (wt %) | (wt) | (μF) | (mΩ) | (%) | ΔESR/ESR | Failure (number) |
| Example 1 | 0.05 | 10 | 2:1 | 145 | 34.5 | −5.3 | 1.45 | 2/30 |
| Example 2 | 0.1 | 10 | 2:1 | 155 | 26.4 | −2.4 | 1.04 | 0/30 |
| Example 3 | 0.5 | 10 | 2:1 | 152 | 23.2 | −2.3 | 1.01 | 0/30 |
| Example 4 | 1.0 | 10 | 2:1 | 151 | 25.7 | −3.7 | 1.08 | 0/30 |
| Example 5 | 2.0 | 10 | 2:1 | 149 | 41.2 | −4.6 | 1.22 | 0/30 |
| Example 6 | 0.5 | 1 | 2:1 | 147 | 35.8 | −5.6 | 1.32 | 1/30 |
| Example 7 | 0.5 | 5 | 2:1 | 153 | 27.4 | −4.3 | 1.11 | 0/30 |
| Example 8 | 0.5 | 20 | 2:1 | 154 | 32.6 | −3.3 | 1.07 | 0/30 |
| Example 9 | 0.5 | 25 | 2:1 | 152 | 40.5 | −4.8 | 1.12 | 0/30 |
| Comparative | 0 | 0 | 2:1 | 149 | 33.3 | −5.5 | 1.80 | 4/30 |
| Example 1 | | | | | | | | |
| Comparative | 0.5 | 0 | 2:1 | 139 | 40.1 | −6.7 | 1.78 | 3/30 |
| Example 2 | | | | | | | | |
| Comparative | 0 | 10 | 2:1 | 144 | 35.0 | −5.2 | 1.66 | 3/30 |
| Example 3 | | | | | | | | |

The solid electrolytic capacitors in accordance with Examples 1 to 9 and Comparative Examples 1 to 3 had a rated voltage of 4 V, a rated capacity of 150 μF, and outer dimensions of 6.3 mm in diameter and 6 mm in height. In each of Examples 1 to 9 and Comparative Examples 1 to 3, 50 solid electrolytic capacitors were fabricated, and measurement of values of (1) and (2) described below was performed on 30 solid electrolytic capacitors randomly selected from the 50 solid electrolytic capacitors. Table 1 shows average values thereof.

(1) initial capacitance (μT) of the solid electrolytic capacitor at a frequency of 120 Hz;
(2) ESR (mΩ) at a frequency of 100 kHz.

Further, a reflow test was conducted on the solid electrolytic capacitor subjected to the measurement of the initial capacitance and the ESR. The reflow test was conducted under the conditions of keeping the solid electrolytic capacitor at 230° C. or more for 30 seconds, with a maximum temperature of 250° C.

As changes in properties of the solid electrolytic capacitor caused by the reflow test, a capacitance change rate (ΔC/C (%)) and an ESR change rate (ΔESR/ESR (times)) are indicated. The capacitance change rate and the ESR change rate are represented by the following equations (1) and (2):

ΔC/C(%)=(C−C0)/C0×100 equation (1);

ΔESR/ESR(times)=R/R0 equation (2),

where C0 and R0 are an initial capacitance and an initial ESR of the solid electrolytic capacitor, respectively, and C and R are a capacitance value and an ESR of the solid electrolytic capacitor after the reflow test.

Further, the number of occurrence of a short circuit failure indicated in Table 1 is the number of the solid electrolytic capacitors for which it was confirmed that, when a rated voltage of 4 V was applied to the solid electrolytic capacitors after the reflow test, a voltage of 4 V was not applied to the solid electrolytic capacitors and a current of 0.5 A or more flowed. Such solid electrolytic capacitors were considered as damaged.

As can be seen from the numbers of occurrence of a short circuit failure indicated in Table 1, in the solid electrolytic capacitors in accordance with Examples 1 to 9, the numbers of occurrence of a short circuit failure after the reflow test were smaller than those in Comparative Examples 1 to 3. It was confirmed that this is an effect produced by containing both the chelating agent and the cyclic siloxane in the dopant and oxidant solution. It was also found to be particularly preferable that the chelating agent in the dopant and oxidant solution has a concentration in a range of 0.1 to 1.0 wt %, and the cyclic siloxane in the dopant and oxidant solution has a concentration in a range of 5 to 20 wt %.

Next, a composition of a cleaning liquid and performance of a manufactured solid electrolytic capacitor were examined.

### Examples 10 to 12

Respective solid electrolytic capacitors were manufactured by the same method as in Example 3 except for changing the concentration of para toluene sulfonic acid in the cleaning liquid used for cleaning the anode in Example 3 to those indicated in Table 2.

TABLE 2

| | Concentration in Dopant and | | | | | After Reflow Test | | |
|---|---|---|---|---|---|---|---|---|
| | Oxidant Solution | | Concentration of | Initial | Initial | | | Number of Occurrence |
| | Chelating | Cyclic Siloxane | Aromatic Sulfonic Acid in | Capacitance | ESR | ΔC/C | | of Short Circuit |
| | Agent (wt %) | (wt %) | Cleaning Liquid (wt %) | (μF) | (mΩ) | (%) | ΔESR/ESR | Failure (number) |
| Example 10 | 0.5 | 10 | 0.5 | 150 | 24.3 | −4.4 | 1.10 | 0/30 |
| Example 3 | | | 2 | 152 | 23.2 | −2.3 | 1.01 | 0/30 |
| Example 11 | | | 3 | 150 | 24.5 | −3.3 | 1.04 | 0/30 |
| Example 12 | | | 5 | 148 | 25.9 | −3.4 | 1.08 | 4/30 |
| Comparative | 0 | 10 | 2 | 144 | 35.0 | −5.2 | 1.66 | 3/30 |
| Example 3 | | | | | | | | |

The solid electrolytic capacitors in accordance with Examples 10 to 12 were also examined as in the solid electrolytic capacitors in accordance with Examples 1 to 9. As can be seen from Table 2, the number of occurrence of a short circuit failure was reduced when the aromatic sulfonic acid in the cleaning liquid used in the process of manufacturing the solid electrolytic capacitor in accordance with the present invention had a concentration of 0.5 wt % to 3.0 wt %. Therefore, it was found to be particularly preferable that the aromatic sulfonic acid in the cleaning liquid has a concentration of 0.5 wt % to 3.0 wt %.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A solid electrolytic capacitor, comprising:
an anode having a dielectric coating film on a surface thereof; and
a solid electrolyte layer including a conductive polymer,
said solid electrolyte layer containing a cyclic siloxane and a chelating agent.

2. The solid electrolytic capacitor according to claim 1, wherein said cyclic siloxane includes at least one selected from hexamethyl cyclotrisiloxane, octamethyl cyclotetrasiloxane, decamethyl cyclopentasiloxane, and dodecamethyl cyclohexasiloxane.

3. The solid electrolytic capacitor according to claim 1, wherein said chelating agent includes at least one selected from ethylenediamine tetraacetic acid, propanediamine tetraacetic acid, diaminohydroxypropane tetraacetic acid, nitrilo triacetic acid, glycol ether diamine tetraacetic acid, diethylenetriatnine pentaacetic acid, hydroxyethylethylenediamine triacetic acid, and triethylenetetramine hexaacetic acid.

4. A method of manufacturing a solid electrolytic capacitor including an anode having a dielectric coating film on a surface thereof and a solid electrolyte layer including a conductive polymer, said method comprising the steps of:
preparing a polymerization liquid by mixing a precursor monomer of said conductive polymer and a dopant and oxidant solution containing a sulfonic acid metal salt, a cyclic siloxane, and a chelating agent;
bringing said polymerization liquid into contact with said dielectric coating film; and
forming said conductive polymer by polymerizing the precursor monomer in contact with said dielectric coating film.

5. The method of manufacturing a solid electrolytic capacitor according to claim 4, wherein said cyclic siloxane in said dopant and oxidant solution has a concentration of 5 to 20 wt %.

6. The method of manufacturing a solid electrolytic capacitor according to claim 4, wherein said chelating agent in said dopant and oxidant solution has a concentration of 0.1 to 1.0 wt %.

7. The method of manufacturing a solid electrolytic capacitor according to claim 4, further comprising the step of cleaning said anode with a cleaning liquid containing an aromatic sulfonic acid after the step of bringing said polymerization liquid into contact with said dielectric coating film.

8. The method of manufacturing a solid electrolytic capacitor according to claim 7, wherein the aromatic sulfonic acid contained in said cleaning liquid has a concentration of 0.5 to 3.0 wt %.

9. A method of manufacturing a solid electrolytic capacitor including an anode having a dielectric coating film on a surface thereof and a solid electrolyte layer including a conductive polymer, said method comprising the steps of:
preparing a dopant and oxidant solution containing a sulfonic acid metal salt, a cyclic siloxane, and a chelating agent;
preparing a polymerization liquid by mixing said dopant and oxidant solution and a precursor monomer of said conductive polymer;
bringing said polymerization liquid into contact with said dielectric coating film; and
forming said conductive polymer by polymerizing the precursor monomer in contact with said dielectric coating film.

10. The method of manufacturing a solid electrolytic capacitor according to claim 9, wherein said cyclic siloxane in said dopant and oxidant solution has a concentration of 5 to 20 wt %.

11. The method of manufacturing a solid electrolytic capacitor according to claim 9, wherein said chelating agent in said dopant and oxidant solution has a concentration of 0.1 to 1.0 wt %.

12. The method of manufacturing a solid electrolytic capacitor according to claim 9, further comprising the step of cleaning said anode with a cleaning liquid containing an aromatic sulfonic acid after the step of bringing said polymerization liquid into contact with said dielectric coating film.

13. The method of manufacturing a solid electrolytic capacitor according to claim 12, wherein the aromatic sulfonic acid contained in said cleaning liquid has a concentration of 0.5 to 3.0 wt %.

14. A method of manufacturing a solid electrolytic capacitor including an anode having a dielectric coating film on a surface thereof and a solid electrolyte layer including a conductive polymer, said method comprising the steps of:
preparing a dopant and oxidant solution containing a sulfonic acid metal salt, a cyclic siloxane, and a chelating agent, and bringing said dopant and oxidant solution into contact with said dielectric coating film;
bringing a precursor monomer of said conductive polymer into contact with said dielectric coating film; and
forming said conductive polymer by polymerizing the precursor monomer in contact with said dielectric coating film.

15. The method of manufacturing a solid electrolytic capacitor according to claim 14, wherein said cyclic siloxane in said dopant and oxidant solution has a concentration of 5 to 20 wt %.

16. The method of manufacturing a solid electrolytic capacitor according to claim 14, wherein said chelating agent in said dopant and oxidant solution has a concentration of 0.1 to 1.0 wt %.

17. The method of manufacturing a solid electrolytic capacitor according to claim 14, further comprising the step of cleaning said anode with a cleaning liquid containing an aromatic sulfonic acid after the step of bringing said precursor monomer into contact with said dielectric coating film.

18. The method of manufacturing a solid electrolytic capacitor according to claim 17, wherein the aromatic sulfonic acid contained in said cleaning liquid has a concentration of 0.5 to 3.0 wt %.

19. A method of manufacturing a solid electrolytic capacitor including an anode having a dielectric coating film on a surface thereof and a solid electrolyte layer including a conductive polymer, said method comprising the steps of:
bringing a precursor monomer of said conductive polymer into contact with said dielectric coating film;
preparing a dopant and oxidant solution containing a sulfonic acid metal salt, a cyclic siloxane, and a chelating agent, and bringing said dopant and oxidant solution into contact with said dielectric coating film; and
forming said conductive polymer by polymerizing the precursor monomer in contact with said dielectric coating film.

20. The method of manufacturing a solid electrolytic capacitor according to claim 19, wherein said cyclic siloxane in said dopant and oxidant solution has a concentration of 5 to 20 wt %.

21. The method of manufacturing a solid electrolytic capacitor according to claim 19, wherein said chelating agent in said dopant and oxidant solution has a concentration of 0.1 to 1.0 wt %.

22. The method of manufacturing a solid electrolytic capacitor according to claim 19, further comprising the step of cleaning said anode with a cleaning liquid containing an aromatic sulfonic acid after the step of bringing said dopant and oxidant solution into contact with said dielectric coating film.

23. The method of manufacturing a solid electrolytic capacitor according to claim 22, wherein the aromatic sulfonic acid contained in said cleaning liquid has a concentration of 0.5 to 3.0 wt %.
